(19) United States
(12) Patent Application Publication
(10) Pub. No.: US 2012/0079881 A1
(43) Pub. Date: Apr. 5, 2012

(54) Measuring Vessel with a Counting Device

(76) Inventor: Cynthia Olson, Decatur, GA (US)

(21) Appl. No.: 13/247,112

(22) Filed: Sep. 28, 2011

Related U.S. Application Data
(60) Provisional application No. 61/388,193, filed on Sep. 30, 2010.

(51) Int. Cl. G01F 19/00

(52) U.S. Cl. 73/426

(57) ABSTRACT

A measuring vessel comprising a cavity, a handle connected to the cavity, and a counter disposed on the handle is provided, wherein the counter is advanced by a user with each use to tally a number of times the measuring vessel is used to measure a volume, and wherein the counter is a low-profile counter that permits the measuring vessel to be stored as a member of a close-nesting set. A close-nesting set of a plurality of graduated measuring vessels is also provided.

### RELATED APPLICATION

This application claims priority under 35 U.S.C. 119(e) to U.S. Provisional Application Ser. No. 61/388,193, filed Sep. 30, 2010, the contents of which are incorporated herein in their entirety.

### FIELD OF THE INVENTION

The present invention relates to the field of measuring vessels. Specifically, the invention relates to measuring vessels comprising a low-profile counter for counting the number of times the measuring vessel has been used, for example, to measure a volume. The counter is a low-profile counter so that the measuring vessels are close-nesting for convenient kitchen storage.

### BACKGROUND OF THE INVENTION

Recipes often require the measurement and addition of large volumes of dry or wet ingredients. Frequently, and especially in the case of doubling or tripling recipes or cooking for large numbers of people, an individual may be required to measure multiple volumes of ingredients, such as flour, sugar, cereal, milk, oil, and the like. A common problem encountered by many cooks is the difficulty of tallying the number of times a given volume has been measured and dispensed. Many times, the cook loses count and must resort to guessing or estimating the number of volumes measured and added. Similarly, losing count of the number of times a measuring vessel has been used makes it difficult for the cook to know the total volume of an ingredient that has been measured and dispensed. Especially with respect to baking recipes, wherein the exact measurement of wet and dry ingredients is particularly important, such guessing or estimating can result in failed products.

Additionally, certain recipes may require the cook to keep track of how many times she has performed a specific action, such as stirring the contents of a bowl or other receptacle.

U.S. Pat. No. 5,884,523, issued Mar. 23, 1999, to Cheng et al., discloses a scoop for measuring powder comprising a leveling pusher which activates a ratcheting counter to count scooping frequency. However, the device of Cheng et al. is bulky, complicated, and requires the leveling pusher to activate the counting ratchet.

U.S. Pat. No. 6,470,745, issued Oct. 29, 2002, to Reay et al., discloses a dispensing scoop having a powder leveling means flexibly integrated into the handle and a ratcheting counter that is automatically advanced by operation of the powder leveling means. Again, the Reay et al. device is bulky and, with the long leveling arm extending from the handle, awkward to both use and store.

A need exists for a convenient, easy-to-store device to aid the cook in tallying the number of times a measuring vessel has been used and the total volume measured, or keep track of the number of times a utensil, such as a spoon, has been used to perform a given action, such as stirring the contents of a bowl.

### SUMMARY OF THE INVENTION

The present invention overcomes the challenge by providing measuring vessels having low-profile counters disposed on the handles for tallying the number of times the utensil is used and the total volume measured.

In one embodiment of the invention, a measuring vessel comprising a cavity, a handle connected to the cavity, and a counter disposed on the handle is provided, wherein the counter is advanced by a user with each use to tally a number of times the measuring vessel is used to measure a volume, and wherein the counter is a low-profile counter that permits the measuring vessel to be stored as a member of a close-nesting set.

In another embodiment of the invention, close-nesting set of a plurality of graduated measuring vessels is provided, each measuring vessel comprising a cavity, a handle connected to the cavity, and a low-profile counter disposed on the handle, wherein the low-profile counter is advanced by a user with each use to tally a number of times a measuring vessel is used to measure a volume, and wherein the low-profile counter permits the plurality of graduated measuring vessels to be stored as a close-nesting set.

These and other objects, features, and advantages will become apparent to those of ordinary skill in the art from a reading of the following detailed description and the appended claims.

### BRIEF DESCRIPTION OF THE DRAWINGS

FIG. 1. A measuring vessel with an analog counter. The analog counter is advanced manually, by rotating a low-profile radial dial coupled to the handle about an axis generally perpendicular to the top surface of the handle.

FIG. 2. A close-nesting set of measuring cups, each measuring cup having a low-profile radial dial counter disposed on the handle. The radial dial counters are low-profile, such that the counter does not substantially interfere with the close-nesting feature of the measuring cups.

FIG. 3. Top view of a close-nesting set of measuring cups, each measuring cup having a low-profile radial dial counter disposed on the handle.

FIG. 4. A close-nesting set of measuring cups, each measuring cup having a low-profile digital counter disposed on the handle. The digital counters are low-profile, such that the counter does not substantially interfere with the nesting feature of the measuring cups. The digital counter received audio or manual input from the user.

FIG. 5. Top view of a close-nesting set of measuring cups, each measuring cup having a low-profile digital counter disposed on the handle. The digital counters are low-profile, such that the counter does not substantially interfere with the close-nesting feature of the measuring cups. The digital counter receives audio or manual input from the user.

FIG. 6. A close-nesting set of measuring cups, each measuring cup having a low-profile sliding switch counter disposed on the handle. The sliding switch counters are low-profile, such that the counter does not substantially interfere with the close-nesting feature of the measuring cups.

FIG. 7. Top view of a close-nesting set of measuring cups, each measuring cup having a low-profile sliding switch counter disposed on the handle. The sliding switch counters are low-profile, such that the counter does not substantially interfere with the close-nesting feature of the measuring cups.

### DETAILED DESCRIPTION OF THE INVENTION

The term “measuring vessel,” as used herein, refers to any vessel used in food preparation for measuring wet or dry ingredients. A measuring vessel includes, for example, measuring cups and spoons for measuring either wet or dry ingredients. A measuring vessel can be a vessel of any size practical for kitchen use, including standard sized measuring cups or spoons as well as larger vessels, including but not limited to, beakers, pots, pans, and the like. In the case of measuring cups and spoons, the measuring vessels optionally have a hole or aperture in the handle at the end distal to the cavity, such that when stored as a close-nesting set, the measuring vessels can be connected by a connector passing through the hole or aperture in the handles. The connector can be any device that holds the set together for storage, for example, a ring of metal or plastic or a flexible tie or ribbon. In one embodiment, the connector is removably attached, such that the measuring vessels can be separated from the set for use, and then returned to the set and held together for convenient storage.

The term “counter,” as used herein, refers to any device which allows a user of a utensil to tally the number of times the measuring vessel is used to measure a volume. In one embodiment, the counter tallies the number of times a measuring vessel is used by a user. In another embodiment, the counter tallies the total volume measured after each use by a user. The counter can be, for example, an analog counter or a digital counter. The analog counter is advanced manually, for example, by the user's finger manipulating the counter. A digital counter can be advanced either manually, or via voice activation.

The term “close-nesting,” as used herein, refers to an object that fits together in a set of objects of graduated size, e.g., each fitting within the one immediately larger, such that the objects fit together substantially closely, without excessive space in between each object, for convenient kitchen storage. A close-nesting measuring cup refers to a measuring cup in a set of graduated cups, wherein each cup fits within the cup immediately larger, without excessive space between each measuring cup when stored together as a nested set. Standard measuring cup sets include, for example, ¼ cup, ⅓ cup, ½ cup, and 1 cup sizes. Other common measuring cup sizes include, but are not limited to, ⅛ cup, ⅔ cup, ¾ cup, 2 cup sizes, and any other whole or fractional size practical for kitchen use. A close-nesting measuring spoon refers to a measuring spoon in a set of graduated spoons, wherein each spoon fits within the spoon immediately larger, without excessive space between each measuring spoon when stored together as a set. Standard measuring spoon sizes include, for example, ¼ teaspoon, ½ teaspoon, 1 teaspoon, and 1 tablespoon sizes. Other common measuring spoon sizes include, but are not limited to, ⅛ teaspoon, ⅔ teaspoon, ¾ teaspoon, ½ tablespoon sizes, pinch, dash, smidgen, and any other whole or fractional size practical for kitchen use.

A close-nesting set of measuring vessels, as used here, refers to a set of a plurality of measuring vessels of graduated size, each measuring vessel fitting within the one immediately larger, such that the set of measuring vessels fits together without excessive space in between each measuring vessel, for convenient kitchen storage. Optionally, the close-nesting set of measuring vessels is stored together with a connector connecting each measuring vessel through a hole or aperture in the handle. The connector is optionally removable.

One skilled in the art will appreciate the various United States and metric units suitable for measuring volumes of wet and dry ingredients, including, but not limited to, teaspoon, tablespoon, cup, pint, quart, gallon, ounce, fluid ounce, pound, milliliter, liter, gram, and kilogram, any of which may be used in various embodiments of the measuring vessels of the present invention.

In one embodiment of the invention, a measuring vessel is provided, comprising a cavity, a handle connected to the cavity, and a counter disposed on the handle, wherein the counter is advanced by a user with each use to tally a number of times the measuring vessel is used to measure a volume, and wherein the counter is a low-profile counter that permits the measuring vessel to be stored as a member of a close-nesting set.

In a specific embodiment, the measuring vessel is selected from the group consisting of measuring cups and measuring spoons. In one embodiment, the counter tallies the number of times a measuring vessel is used, displaying integers such as 0, 1, 2, 3, 4, 5, 6, 7, 8, 9, 10, etc. In another specific embodiment, counter advances by units equivalent to the volume of the measuring vessel, such that advancement of the counter with each use of the measuring vessel tallies a cumulative volume measured. For example, a measuring cup measuring a ¼ cup volume has a counter that advances in ¼ cup increments. Upon first use, the user advances the counter one place to display “¼”. Upon second use, the user advances the counter a second place to display “½”. Upon a third use, the user advances the counter a third place to display “¾”. Upon a fourth use, the user advances the counter a fourth place to display “1,” and so forth. In one embodiment, the counter displays a cumulative volume measured as the counter is advanced with each use by the user.

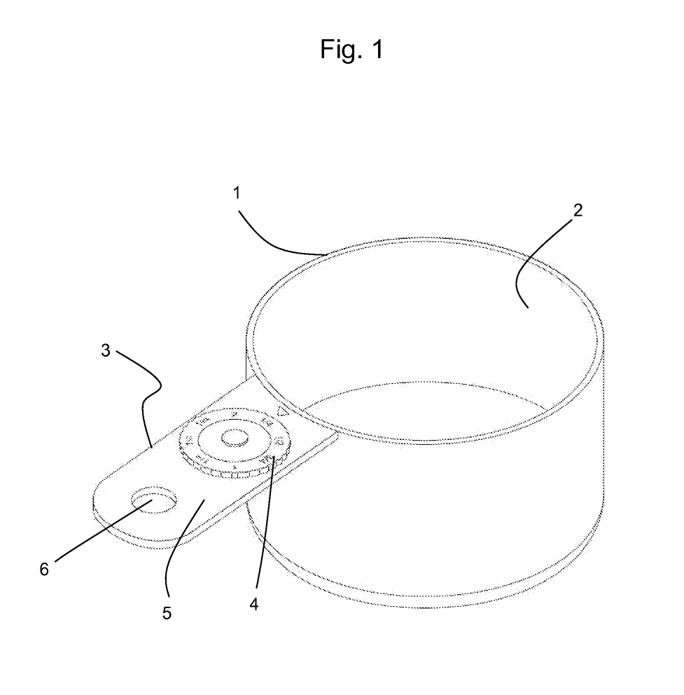

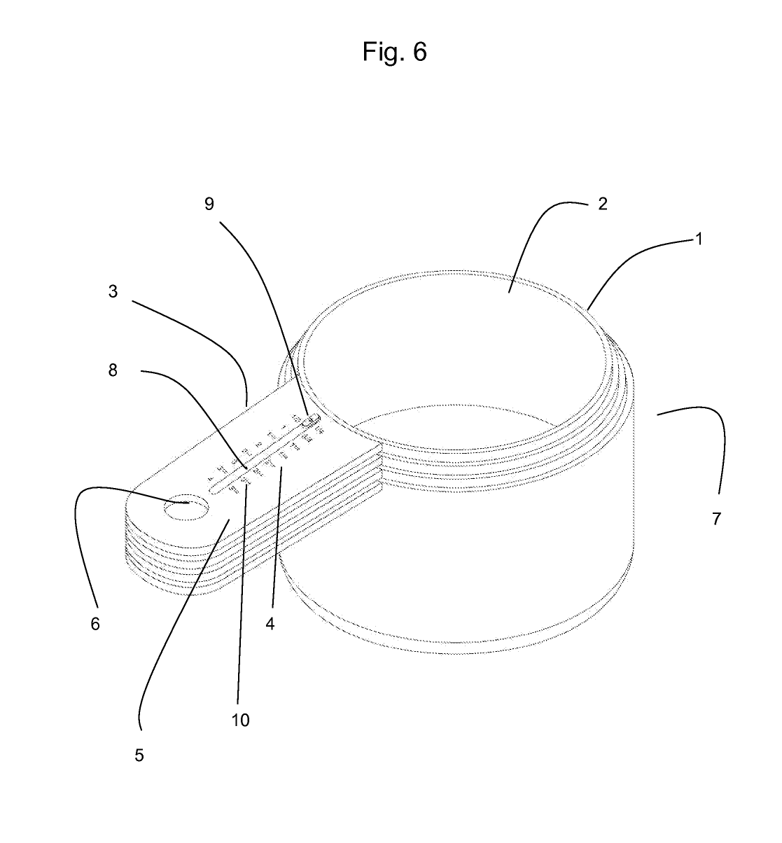

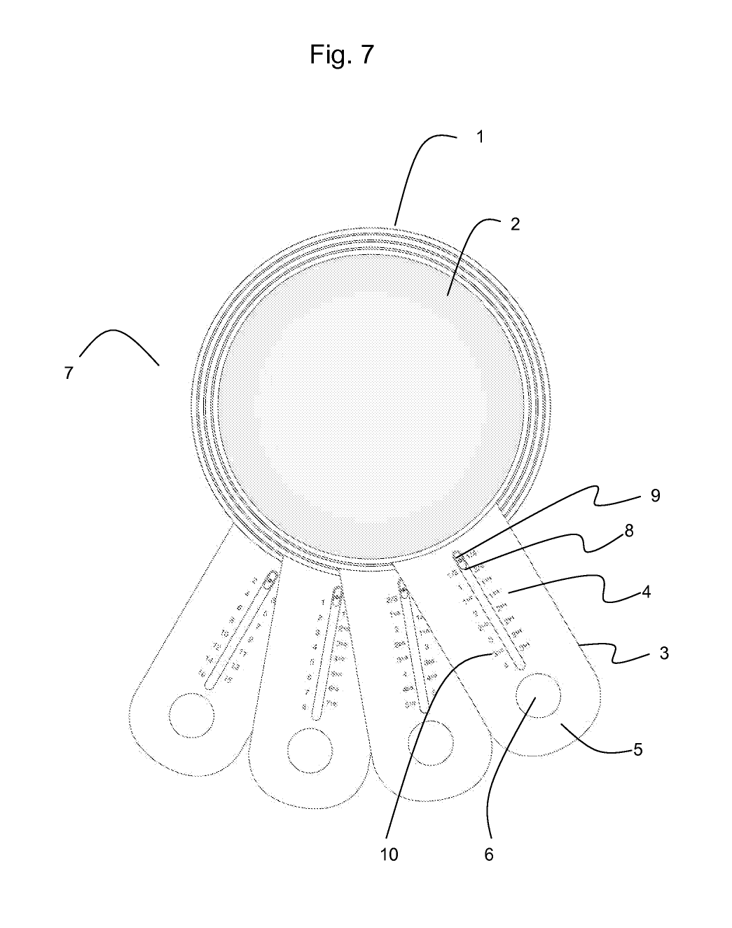

In another embodiment, the counter is selected from the group consisting of analog counters and digital counters. One skilled in the art will appreciate that any low-profile counter can be employed in the present invention, as long as the counter does not interfere substantially with the nesting feature of the measuring vessels. In a specific embodiment, the analog counter is selected from the group consisting of a radial dial (see FIGS. 1-3, for example) and a sliding switch (see FIGS. 6-7, for example). In a specific embodiment, the radial dial is coupled to the handle about an axis generally perpendicular to a top surface of the handle, such that the dial is easily manipulated by the finger or thumb of the user (FIG. 1).

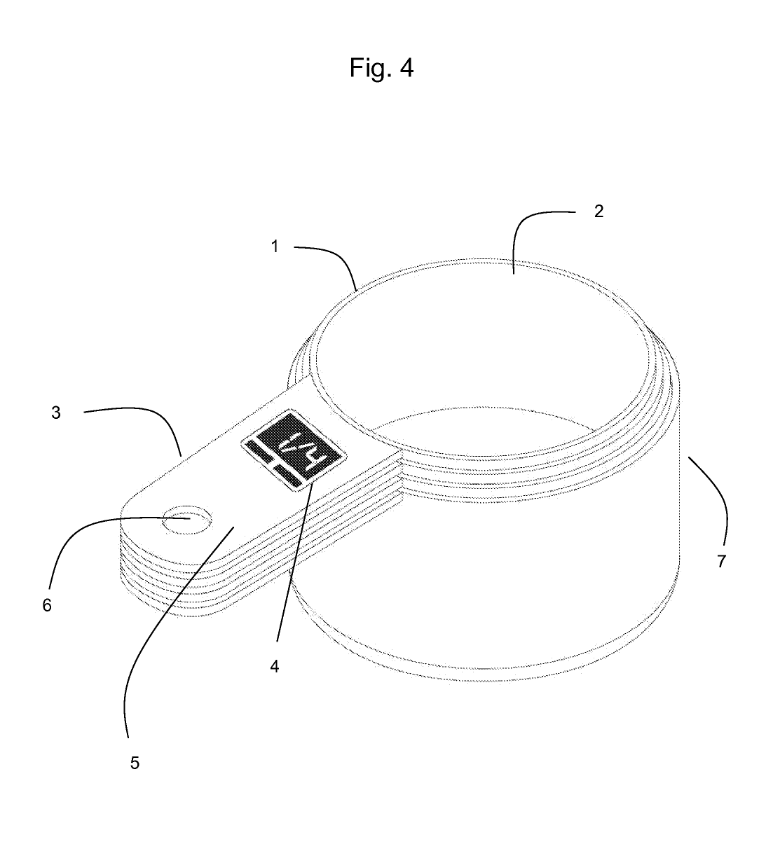

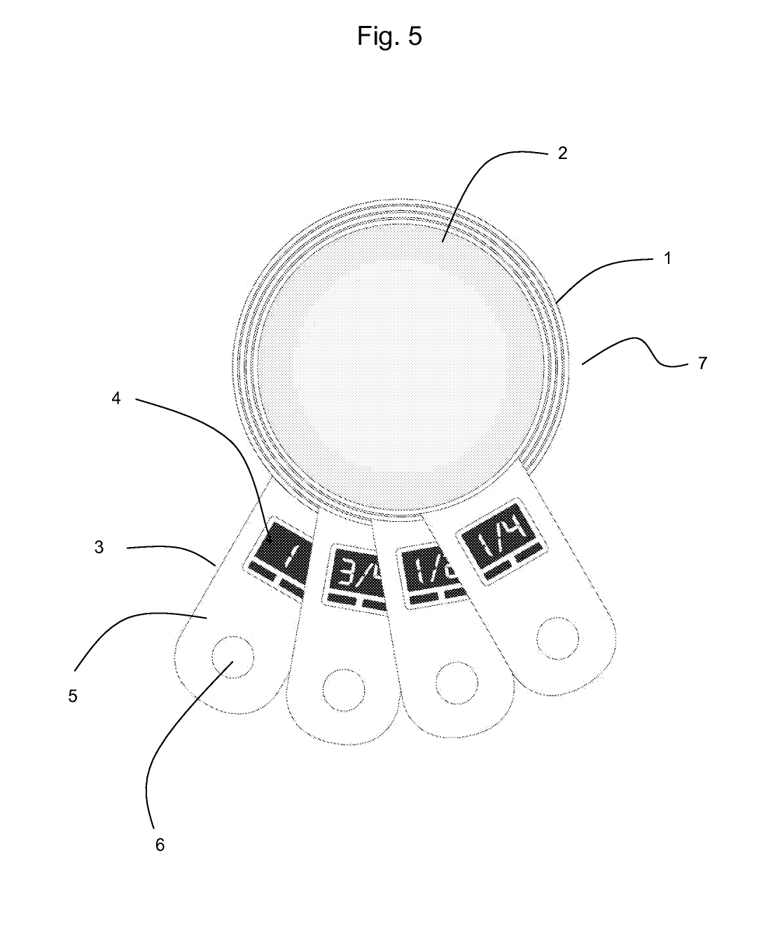

In another embodiment of the invention, the counter is a digital counter. In a specific embodiment, the counter receives manual input, for example, the user inputs data by pressing a button on the handle of the utensil (see FIGS. 4-5, for example). In another embodiment, the counter receives audio input, for example, the user inputs data by speaking and the digital counter is activated by detecting the voice of the user.

In another embodiment of the invention, a close-nesting set of a plurality of graduated measuring vessels is provided, each measuring vessel comprising a cavity, a handle connected to the cavity, and a low-profile counter disposed on the handle, wherein the low-profile counter is advanced by a user with each use to tally a number of times a measuring vessel is used to measure a volume, and wherein the low-profile counter permits the plurality of graduated measuring vessels to be stored as a close-nesting set. In a specific embodiment, the measuring vessel is selected from the group consisting of measuring cups and measuring spoons.

In a specific embodiment, the measuring vessels have a hole or aperture in the handle at the end distal to the cavity, such that when stored as a close-nesting set, the measuring vessels can be connected by a connector passing through the hole or aperture in the handles. The connector can be any device that holds the set together for storage, for example, a ring of metal or plastic or a flexible tie, string, or ribbon. In one embodiment, the connector is removably attached, such that the measuring vessels can be separated from the set for use, and then returned to the set for convenient storage.

In another embodiment of the invention, a kitchen utensil with a counter is provided, wherein the counter is used to keep track of the number of times a utensil, such as a spoon, has been used to perform a given action, such as stirring the contents of a bowl. In a specific embodiment, the counter is removably attached to the kitchen utensil. Non-limiting examples of suitable kitchen utensils include spoons, spatulas, whisks, ladles, and the like.

Referring to the drawings, FIG. 1 shows a measuring vessel 1 comprising a cavity 2, a handle 3 connected to the cavity, and a counter 4 disposed on the handle. The counter 4 is a radial dial counter, which is advanced by a user with each use of the measuring vessel 1, to tally a number of times the measuring vessel is used, or to tally the total volume measured after each use. The measuring vessel 1 has a handle 3 with a top surface 5, for affixing the counter 4. The handle also has an aperture 6, through which a connector can be passed to connect a set of measuring vessels stored together as a close-nesting set.

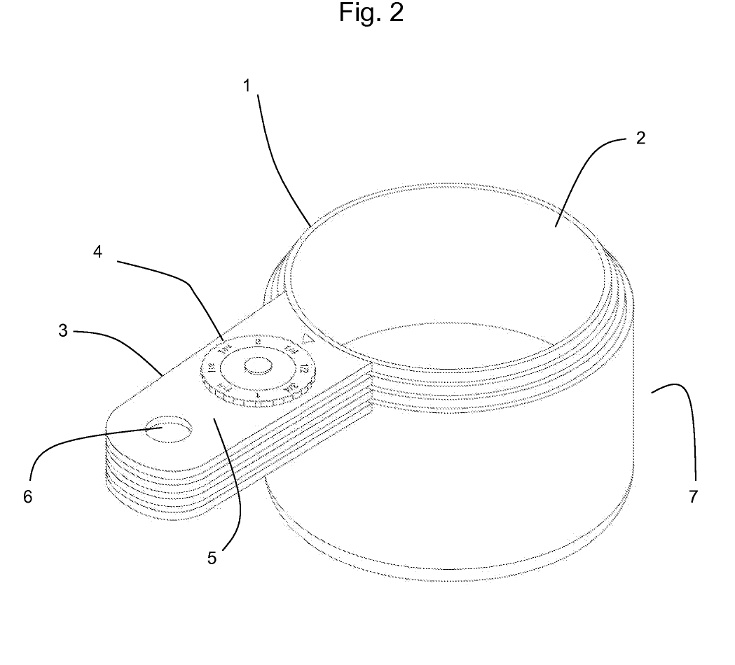

FIG. 2 shows a close-nesting set 7 of measuring vessels 1, each measuring vessel 1 comprising a cavity 2, a handle 3 connected to the cavity, and a counter 4 disposed on the handle. Each counter 4 is a radial dial counter, which is coupled to the top surface 5 of the handle 3 and rotates about an axis generally perpendicular to the top surface 5 of the handle 3. The counter 4 on each handle 3 is a low-profile, non-bulky counting device which does not substantially interfere with the close-nesting feature of the measuring cups, such that the set of graduated measuring cups can be stored conveniently in a nested set.

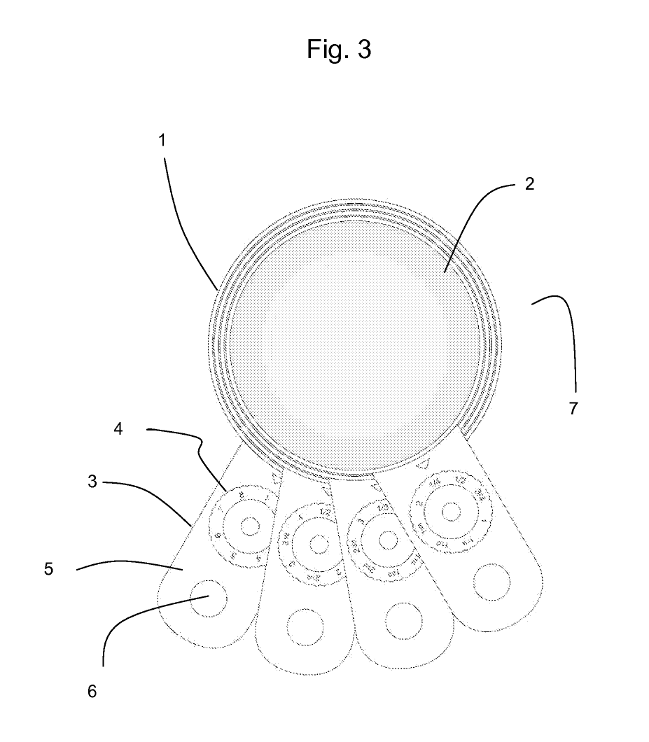

FIG. 3 shows a top view of a close-nesting set 7 of measuring vessels 1, each measuring vessel 1 comprising a cavity 2, a handle 3 connected to the cavity, and a counter 4 disposed on the handle. Each counter 4 is a radial dial counter, which is coupled to the top surface 5 of the handle 3 and rotates about an axis generally perpendicular to the top surface 5 of the handle 3.

FIG. 4 shows a close-nesting set 7 of measuring vessels 1, each measuring vessel 1 comprising a cavity 2, a handle 3 connected to the cavity, and a counter 4 disposed on the handle. Each counter 4 is a digital counter, which is disposed on the top surface 5 of the handle 3. The digital counter receives either manual or audio input. The digital counter 4 on each handle 3 is a low-profile, non-bulky counter which does not substantially interfere with the close-nesting feature of the measuring cups, such that the set of graduated measuring cups can be stored conveniently in a nested set.

FIG. 5 shows a top view of a close-nesting set 7 of measuring vessels 1, each measuring vessel 1 comprising a cavity 2, a handle 3 connected to the cavity, and a counter 4 disposed on the handle. Each counter 4 is a digital counter, which is disposed on the top surface 5 of the handle 3.

FIG. 6 shows a close-nesting set 7 of measuring vessels 1, each measuring vessel 1 comprising a cavity 2, a handle 3 connected to the cavity, and a counter 4 disposed on the handle. Each counter 4 is a sliding switch counter 4, which is disposed on the top surface 5 of the handle 3. The sliding switch counter 4 comprises a channel 8 and a switch 9, wherein the switch 9 slides down the channel 8, which is marked with units 10 equivalent to the volume measured by the cup. The user moves the switch 9 down the channel 8 one unit, each time the measuring cup is used to measure a volume. The sliding switch counter 4 is a low-profile, non-bulky counter which does not substantially interfere with the close-nesting feature of the measuring cups, such that the set of graduated measuring cups can be stored conveniently in a nested set.

FIG. 7 shows a top view of a close-nesting set 7 of measuring vessels 1, each measuring vessel 1 comprising a cavity 2, a handle 3 connected to the cavity, and a counter 4 disposed on the handle. Each counter 4 is a sliding switch counter, comprising a channel 8 and a switch 9.

### Examples

The following examples are given by way of illustration only and are in no way intended to limit the scope of the present invention.

### Example 1

A cook is preparing a recipe that requires 8 cups of puffed rice cereal. The cook uses a one cup measuring cup with a radial dial counter disposed on the handle. The measuring cup is one of a set of graduated measuring cups, including ¼ cup, ½ cup, ⅓ cup, and 1 cup vessels, each cup having a low-profile radial dial counter on the handle. The counter is a radial dial coupled to the handle about an axis generally perpendicular to a top surface of the handle, such as the measuring cup exemplified in FIG. 1. The dial is advanced by the cook's thumb as she uses the measuring cup, such that the counter is advanced to display the total volume measured by the measuring vessel with each use.

The cook fills the cup with the puffed rice cereal and empties the contents into a large bowl. After she empties the contents, she uses her thumb to advance the dial, such that the number displayed on the dial is the number “1.” She then fills the cup again and empties the contents into the bowl. Using her thumb, she advances the dial such that the number “2” is displayed. The cook continues the process until she measures and adds 8 cups of puffed rice cereal into the bowl.

### Example 2

A cook is tripling a recipe that calls for ¾ cup flour. The cook uses a ¾ cup measuring cup with a switch counter disposed on the handle. The measuring cup is one of a set of graduated measuring cups, including ⅛ cup, ¼ cup, ⅓ cup, ½ cup, ⅔ cup, ¾ cup, and 1 cup measuring vessels, each cup having a low-profile sliding switch counter on the handle. The switch is advanced by the cook's thumb as she uses the measuring cup, such that the counter is advanced to display the total volume measured by the measuring vessel with each use.

The cook fills the cup with flour and uses her thumb to advance the switch, such that the number displayed on the dial is the number “¾.” She then fills the cup again and empties the contents unto the bowl. Using her thumb, she advances the switch such that the number “1½” is displayed. The cook continues the process until she measures and adds 2¼ cups flour into the bowl.

All documents cited are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A measuring vessel comprising a cavity, a handle connected to the cavity, and a counter disposed on the handle, wherein the counter is advanced by a user with each use to tally a number of times the measuring vessel is used to measure a volume, and wherein the counter is a low-profile counter that permits the measuring vessel to be stored as a member of a close-nesting set.

2. The measuring vessel of claim 1, wherein the measuring vessel is selected from the group consisting of measuring cups and measuring spoons.

3. The measuring vessel of claim 1, wherein the counter advances by units equivalent to the volume of the measuring vessel, such that advancement of the counter with each use of the measuring vessel tallies a cumulative volume measured.

4. The measuring vessel of claim 1, wherein the counter displays a cumulative volume measured as the counter is advanced by the user with each use.

5. The measuring vessel of claim 1, wherein the counter is selected from the group consisting of analog counters and digital counters.

6. The measuring vessel of claim 5, wherein the counter is an analog counter selected from the group consisting of a radial dial and a sliding switch.

7. The measuring vessel of claim 6, wherein the analog counter comprises a radial dial, wherein the radial dial is coupled to the handle about an axis generally perpendicular to a top surface of the handle.

8. The measuring vessel of claim 5, wherein the counter is a digital counter.

9. The measuring vessel of claim 8, wherein the digital counter receives manual or audio input.

10. A close-nesting set of a plurality of graduated measuring vessels, each measuring vessel comprising a cavity, a handle connected to the cavity, and a low-profile counter disposed on the handle, wherein the low-profile counter is advanced by a user with each use to tally a number of times a measuring vessel is used to measure a volume, and wherein the low-profile counter permits the plurality of graduated measuring vessels to be stored as a close-nesting set.

11. The close-nesting set of a plurality of graduated measuring vessels of claim 10, wherein the close-nesting set is a set of measuring spoons or measuring cups.

12. The close-nesting set of a plurality of graduated measuring vessels of claim 10, wherein the counter advances by units equivalent to a volume of the measuring vessel, such that advancement of the counter with each use of the measuring vessel tallies a cumulative volume measured.

13. The close-nesting set of a plurality of graduated measuring vessels of claim 10, wherein each counter displays a cumulative volume measured as the counter is advanced by the user with each use.

14. The close-nesting set of a plurality of graduated measuring vessels of claim 10, wherein the counter is selected from the group consisting of analog counters and digital counters.

15. The close-nesting set of a plurality of graduated measuring vessels of claim 14, wherein the counter is an analog counter selected from the group consisting of a radial dial and a sliding switch.

16. The close-nesting set of a plurality of graduated measuring vessels of claim 15, wherein the analog counter comprises a radial dial, wherein the radial dial is coupled to the handle about an axis generally perpendicular to a top surface of the handle.

17. The close-nesting set of a plurality of graduated measuring vessels of claim 14, wherein the counter is a digital counter.

18. The close-nesting set of a plurality of graduated measuring vessels of claim 17, wherein the digital counter receives manual or audio input.

19. The close-nesting set of a plurality of graduated measuring vessels of claim 10, wherein the handle of each of said graduated measuring vessels further comprises an aperture at an end of the handle distal to the cavity.

20. The close-nesting set of a plurality of graduated measuring vessels of claim 19, further comprising a connector that passes through the aperture of the handle of each graduated measuring vessel, wherein said connector holds the close-nesting set of a plurality of graduated measuring vessels together for storage.
